(19) United States
(12) Patent Application Publication
(10) Pub. No.: US 2019/0293208 A1
(43) Pub. Date: Sep. 26, 2019

(54) ELECTRONIC CABLE COLLECTION DEVICE

(71) Applicant: MACE GROUP, INC., Ontario, CA (US)

(72) Inventor: YU SHENG LU, TAICHUNG CITY (TW)

(21) Appl. No.: 16/023,132

(22) Filed: Jun. 29, 2018

(30) Foreign Application Priority Data
Mar. 20, 2018 (CN) 201820381102.6

(51) Int. Cl. F16L 3/13; H02G 3/32; F16L 3/22; F16B 1/00

(52) U.S. Cl. CPC F16L 3/13; H02G 3/32; F16B 2001/0035; F16B 1/00; F16L 3/221

(57) ABSTRACT

An electronic cable collection device includes a holding member and a base seat. At least one magnetic attraction body with magnetism is disposed in the base seat. At least one plane connection face is disposed on a surface of the base seat. The holding member has a holding mouth inward recessed from a periphery of the holding member to form two opposite lateral holding sections, which can be elastically bent. A magnetic attracted body is disposed in each lateral holding section, whereby the magnetic attracted body and a magnetic attraction body can attract each other. The holding mouth can be elastically opened to respectively hold different diameters of electronic cables. By means of the magnetic attraction between the magnetic attracted body and magnetic attraction body, the holding members can be easily, quickly and collectively located on the connection face of the base seat.

### BACKGROUND OF THE INVENTION

### 1. Field of the Invention

The present invention relates generally to an electronic cable collection device, and more particularly to an electronic cable collection device, which has a simple structure and is easy to operate and is capable of holding various electronic cables with different diameters.

### 2. Description of the Related Art

Along with the popularization of various electronic apparatuses and 3C products, more and more diversified electronic cables (such as signal transmission cables and charging cables) have been developed and used. In modern life, it has become an important issue how to collect and store various electronic cables. Therefore, many types of electronic cable collection devices for tidily collecting the signal transmission cables and charging cables have been developed and widely commercially available.

FIGS. 1 and 2 show the structure of a traditional cable collection device. The cable collection device mainly includes a holding assembly 3 and a base seat 4. The holding assembly 3 is composed of a holding seat 31 and a holding cap 32. The top side of the holding seat 31 is formed with an upper arched passage 311 with an opening facing upward. Two sides of the holding seat 31 are respectively formed with two insertion channels 312 near the middle of the upper arched passage 311. A magnet (not shown) is additionally inlaid in the bottom side of the holding seat 31. The bottom section of the holding cap 32 is formed with a lower arched passage 321 with an opening facing downward. Two sides of the holding cap 32 are respectively formed with two insertion protrusion sections 322 near the middle of the lower arched passage 321.

The base seat 4 has a locating face 41 for locating the base seat 4 on a predetermined plane face (such as a wall or a table face) and a plane connection face 42. An iron plate (not shown) is disposed in the base seat 4.

In practice, as necessary, a collar 33 is fitted around a predetermined to-be-held section of a coarse electronic cable A (or a middle electronic cable B or a fine electronic cable C, as shown in FIGS. 3 and 4) with a proper diameter. Then, the insertion protrusion sections 322 of the holding cap 32 are extended into the insertion channels 312 of the holding seat 31 to tightly connect the holding cap 32 with the holding seat 31. The lower arched passage 321 cooperates with the upper arched passage 311 to hold the outer circumference of the coarse electronic cable A (or the collar 33). Accordingly, when the coarse electronic cable A is not used, the holding assembly 3 holding the coarse electronic cable A can get close to the base seat 4 and the magnet of the bottom side of the holding seat 31 magnetically attracts the iron plate in the base seat 4 to locate the holding assembly 3 on the base seat 4. In this case, the coarse electronic cables A can be tidily arranged (or hanged) without randomly tangling with each other so as to avoid trouble in use.

However, such kind of holding assembly 3 has more components and a complicated structure. Therefore, the manufacturing cost of the holding assembly 3 is high and the holding assembly 3 is simply applicable to one single diameter of electronic cable so that the use range of the holding assembly 3 is limited. In addition, the collar 33 is fitted around the coarse electronic cable A to protect the skin thereof. However, this leads to inconvenience in use and increase of the manufacturing cost to affect the competitive ability of the whole product. Furthermore, after a long period of use, the magnet of the bottom side of the holding seat 31 is subject to wear and is apt to loosen and detach out of the holding seat 31 to cause failure and damage.

FIGS. 3 and 4 show a traditional cable collection device applicable to different diameters of electronic cables. The cable collection device includes a holding assembly 5 and a base seat 40. The holding assembly 5 is composed of a holding seat 51 and a holding cap 52. The top side of the holding seat 51 is formed with multiple lower fine arched passage 512, lower middle arched passages 513, lower coarse arched passages 514 and multiple sockets 511. The lower fine arched passage 512, lower middle arched passages 513 and lower coarse arched passages 514 pass through the center and intersect each other. Two opposite insertion notches 515 are disposed on the circumference of the holding seat 51. An engagement boss 516 is disposed in each insertion notch 515. A magnet (not shown) is additionally inlaid in the bottom side of the holding seat 51.

The bottom side of the holding cap 52 is formed with multiple upper fine arched passage 522, upper middle arched passages 523, upper coarse arched passages 524 and multiple raised sections 521. The upper fine arched passage 512, upper middle arched passages 513 and upper coarse arched passages 514 pass through the center and intersect each other. Two opposite lateral protrusion sections 525 are disposed on the circumference of the holding cap 52. An engagement hole 526 is formed on each lateral protrusion section 525.

The base seat 40 has a locating face 401 for locating the base seat 40 on a predetermined plane face (such as a wall or a table face) and a plane connection face 402. An iron plate (not shown) is disposed in the base seat 40.

In practice, a proper holding position on the holding seat 51 can be selected in accordance with different diameters of the electronic cables. (For example, a middle electronic cable B with a middle diameter is placed on the lower middle arched passage 513, while a fine electronic cable C with a fine diameter is placed on the lower fine arched passage 512). Then, the raised sections 521 of the holding cap 52 are inserted into the sockets 511 of the holding seat 51 to guide and locate the holding cap 52. At the same time, the lateral protrusion sections 525 are extended into the insertion notches 515 and the engagement bosses 516 are inserted into the engagement holes 526 and securely located therein. At this time, the lower fine arched passage 512, lower middle arched passages 513 and lower coarse arched passages 514 are cooperatively mated with the symmetrical upper fine arched passage 522, upper middle arched passages 523 and upper coarse arched passages 524 to hold the corresponding fine electronic cable C and middle electronic cable B and coarse electronic cable A (not shown). Accordingly, the holding assemblies 5 holding the fine electronic cable C and middle electronic cable B respective get close to the base seat 40. The magnet of the bottom side of the holding seat 51 magnetically attracts the iron plate in the base seat 40 to locate the holding assemblies 5 on the base seat 40. In this case, the fine electronic cable C and middle electronic cable B can be tidily arranged (or hanged) without randomly tangling with each other.

Such kind of holding assembly 5 is applicable to the fine electronic cable C, middle electronic cable B and coarse electronic cable A with different diameters. However, the holding assembly 5 has numerous components and a more complicated structure. Therefore, the research, development and manufacturing cost of the holding assembly 5 is higher and it is quite inconvenient to use the holding assembly 5.

FIGS. 5 and 6 show another traditional cable collection device. The cable collection device includes a holding member 6 and a base seat 10. The holding member 6 has a transverse through hole 62 transversely passing through the middle of the holding member 6 between two sides thereof. A gradually diverged expansion opening 63 extends from the transverse through hole 62 to one side of the holding member 6, whereby the transverse through hole 62 can be elastically outward expanded. In addition, a magnet (not shown) is inlaid in the bottom side of the holding member 6.

In practice, a middle electronic cable B or a fine electronic cable C with a different diameter (or a flat electronic cable D) can be pushed from the expansion opening 63 into the transverse through hole 62. By means of the elasticity of the transverse through hole 62 itself, the middle electronic cable B or the fine electronic cable C (or the flat electronic cable D) can be held and located. Then, the holding member 6 holding the middle electronic cable B or the fine electronic cable C or the flat electronic cable D gets close to the base seat 10. The magnet of the bottom side of the holding member 6 magnetically attracts the iron plate in the base seat 10 to locate the holding member 6 on the base seat 10. In this case, the middle electronic cable B or the fine electronic cable C or the flat electronic cable D can be tidily arranged (or hanged) without randomly tangling with each other.

The transverse through hole 62 of such kind of holding member has the property of elastic expansibility so that the middle electronic cable B or the fine electronic cable C or the flat electronic cable D with different diameters can be held in the transverse through hole 62 and located. However, in such design, the diameter of the transverse through hole 62 cannot be changed to a greater extent so that the coarse electronic cable A with larger diameter cannot be held by the holding member 6. Therefore, such cable collection device still has some shortcomings in use.

Furthermore, all the aforesaid traditional cable collection devices are designed with a structural form with asymmetrical upper and lower sections. In addition, the magnet is simply disposed in the bottom side of the holding member 6 or the holding seat 31, 51 to provide one-way magnetic attraction force. Therefore, in use, only the side of the holding member 6 or the holding seat 31, 51 with the magnet can magnetically attract the base seat 4, 40, 10, while the other side (the top side) cannot provide magnetic attraction effect for the corresponding base seat 4, 40, 10. Such one-side magnetic attraction effect lacks convenience in use and leads to limitation and shortcoming in application.

It is therefore tried by the applicant to provide an electronic cable collection device to eliminate the shortcomings in use of the current cable collection devices.

### SUMMARY OF THE INVENTION

It is therefore a primary object of the present invention to provide an electronic cable collection device including a holding member. The holding member has a holding mouth inward recessed from a periphery of the holding member. A lateral holding section with elastically holding ability is disposed on at least one side of the holding mouth. A magnetic attracted body is disposed in the lateral holding section, whereby the magnetic attracted body and a magnetic attraction body can attract each other.

In the above electronic cable collection device, a raised section is disposed on an inner side of the lateral holding section in adjacency to an opening of the holding mouth.

In the above electronic cable collection device, two lateral holding sections are respectively disposed on two sides of the holding mouth of the holding member, a connection section being connected between the two lateral holding sections, two magnetic attracted bodies being respectively disposed in the lateral holding sections to be attracted by the magnetic attraction body, whereby any of the magnetic attracted bodies of the two lateral holding sections of the holding member can be attracted by the magnetic attraction body to locate the holding member.

In the above electronic cable collection device, the magnetic attracted body is inlaid in one side of the lateral holding section distal from the holding mouth.

In the above electronic cable collection device, the holding member is a structure body with a cross section in the form of a flat disc.

It is a further object of the present invention to provide an electronic cable collection device including a base seat applicable to the aforesaid holding member. The base seat is fixed on a predetermined plane face. At least one magnetic attract ion body with magnetism is disposed in the base seat. At least one plane connection face is disposed on a surface of the base seat.

In the above electronic cable collection device, the holding member is a structure body with a cross section in the form of a flat disc.

In the above electronic cable collection device, multiple magnetic attraction bodies are arranged in the base seat at intervals and the magnetic attracted bodies in the lateral holding sections of multiple holding members are respectively attracted by the corresponding magnetic attraction bodies so as to locate all the holding members holding the electronic cables on the connection face.

In the above electronic cable collection device, the magnetic attraction body is a magnet, while the magnetic attracted body is a magnet or an iron member.

The electronic cable collection device of the present invention is mainly advantageous over the conventional cable collection device in that the electronic cable collection device at least includes a holding member. The holding member has a holding mouth inward recessed from a periphery of the holding member. Two lateral holding sections with elastically holding ability are disposed on two sides of the holding mouth. The lateral holding sections can be elastically opened in accordance with different requirements to snugly hold different diameters of electronic cables. Moreover, the holding member can be located and attached onto a base seat with magnetic attraction ability by way of magnetic attraction. The holding mouth has elasticity so as to directly hold various electronic cables with different diameters without using any other accessory. Therefore, the structure of the electronic cable collection device is simplified and it is convenient to operate the electronic cable collection device. The application range of the electronic cable collection device is widened and the use of the electronic cable collection device is facilitated.

The electronic cable collection device of the present invention is further advantageous over the conventional cable collection device in that a magnetic attraction body is embedded in the base seat. A magnetic attracted body is disposed on at least one lateral holding section of the holding mouth of the holding member to be magnetically attracted by the magnetic attraction body. Therefore, the magnetic attraction body can attract the magnetic attracted body to easily and quickly locate the holding member on the base seat. The magnetic attraction body and the magnetic attracted body are securely disposed in the base seat and the holding member so that the magnetic attraction body and the magnetic attracted body are prevented from loosening and detaching out of the base seat and the holding member. Therefore, the failure and damage that the base seat and the holding member cannot magnetically attract each other to connect with each other can be effectively avoided.

The electronic cable collection device of the present invention is still further advantageous over the conventional cable collection device in that two magnetic attracted bodies can be respectively disposed on two lateral holding sections of the holding member, whereby any side of the holding member can be magnetically attracted and securely located on the base seat. This further enhances the convenience in use of the electronic cable collection device.

The present invention can be best understood through the following description and accompanying drawings, wherein:

### BRIEF DESCRIPTION OF THE DRAWINGS

FIG. 1 is a perspective partially exploded view of a traditional cable collection device;

FIG. 2 is a perspective assembled view of the traditional cable collection device according to FIG. 1;

FIG. 3 is a perspective partially exploded view of another traditional cable collection device;

FIG. 4 is a perspective assembled view of the traditional cable collection device according to FIG. 3;

FIG. 5 is a perspective view of a part of still another traditional cable collection device;

FIG. 6 is a perspective assembled view of the traditional cable collection device according to FIG. 5, showing the practical use thereof;

FIG. 7 is a perspective partially exploded view of the electronic cable collection device of the present invention;

FIG. 8 is a perspective assembled view of the electronic cable collection device of the present invention, showing the practical use thereof; and

FIG. 9 is a side assembled view of a part of the electronic cable collection device of the present invention.

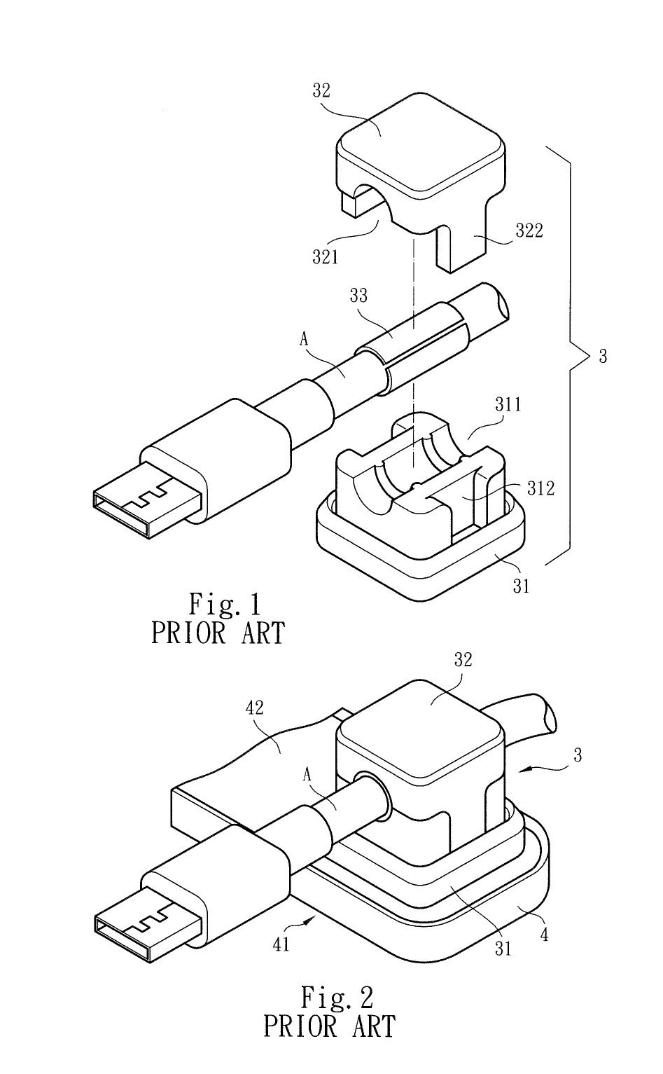

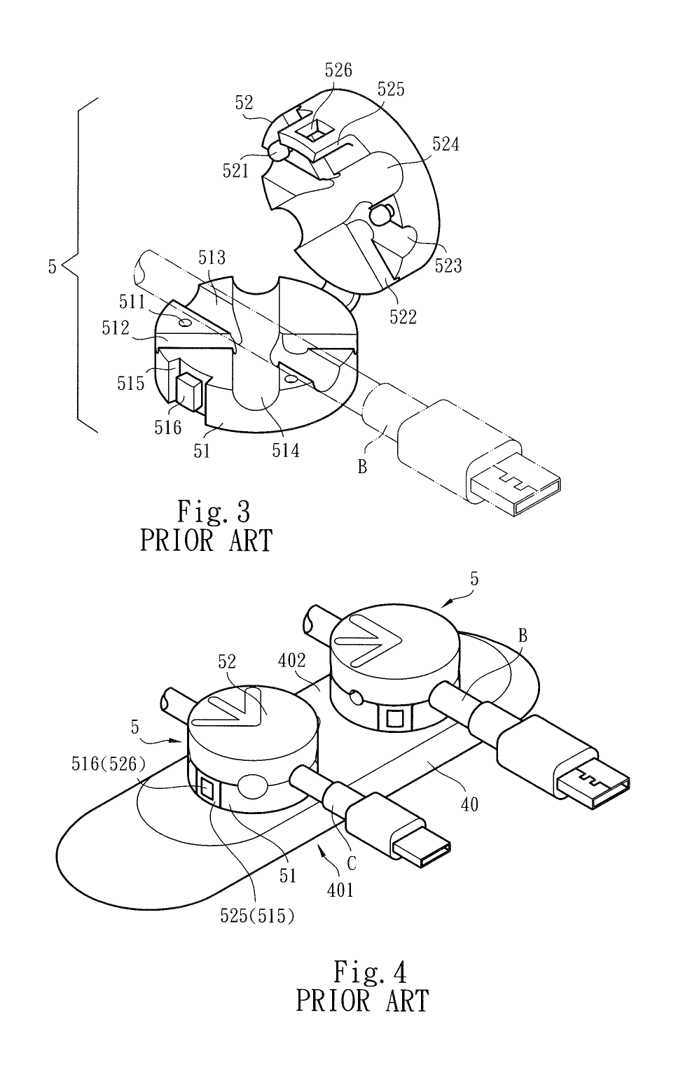

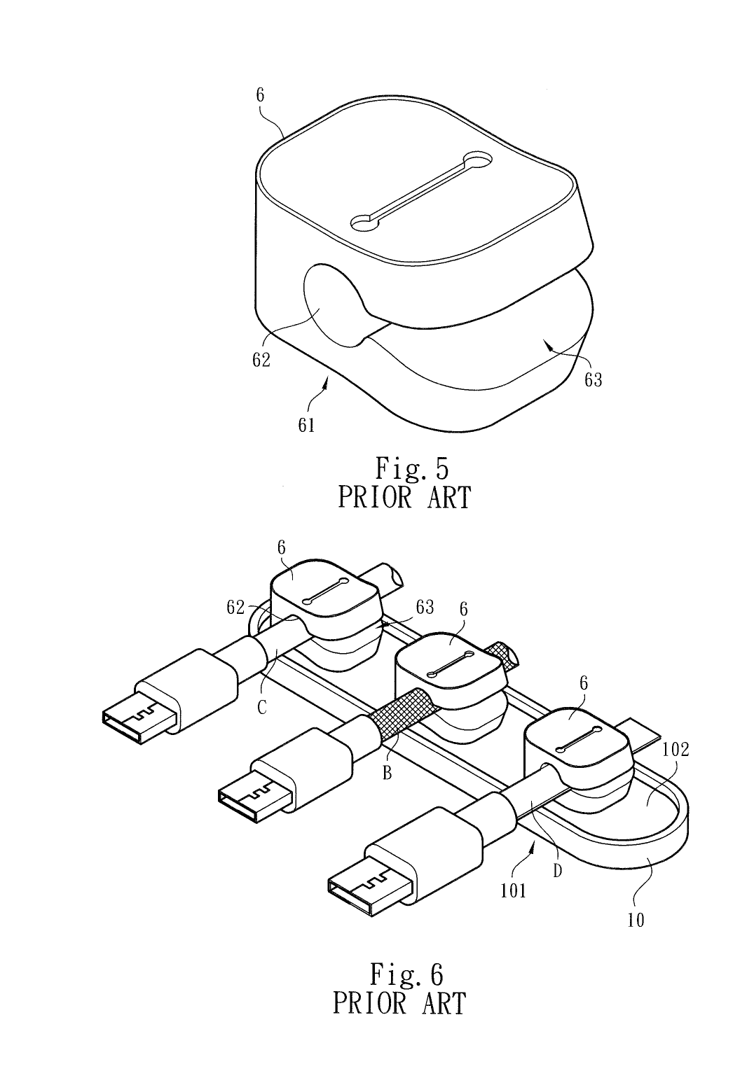

### DETAILED DESCRIPTION OF THE PREFERRED EMBODIMENTS

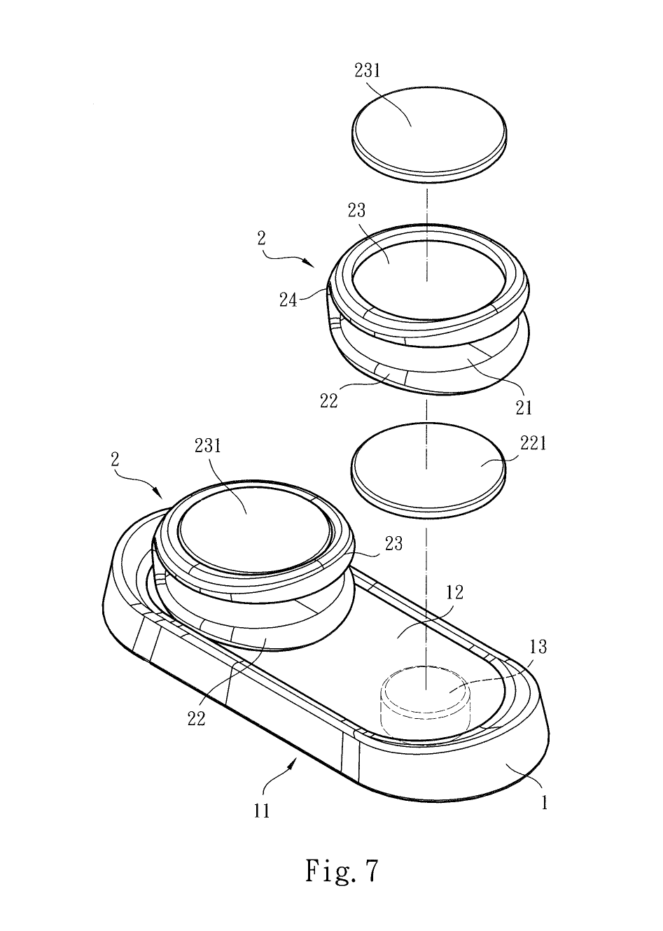

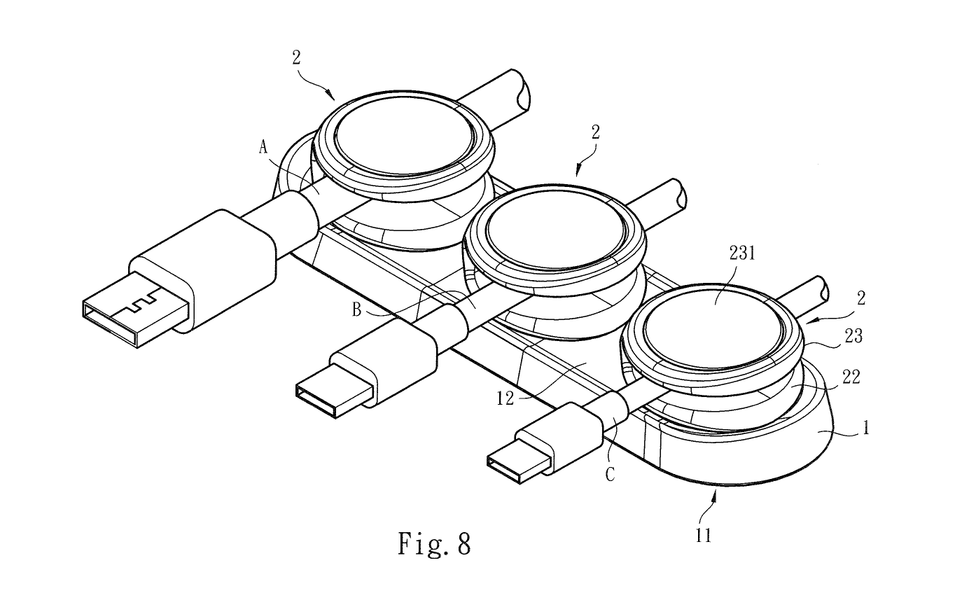

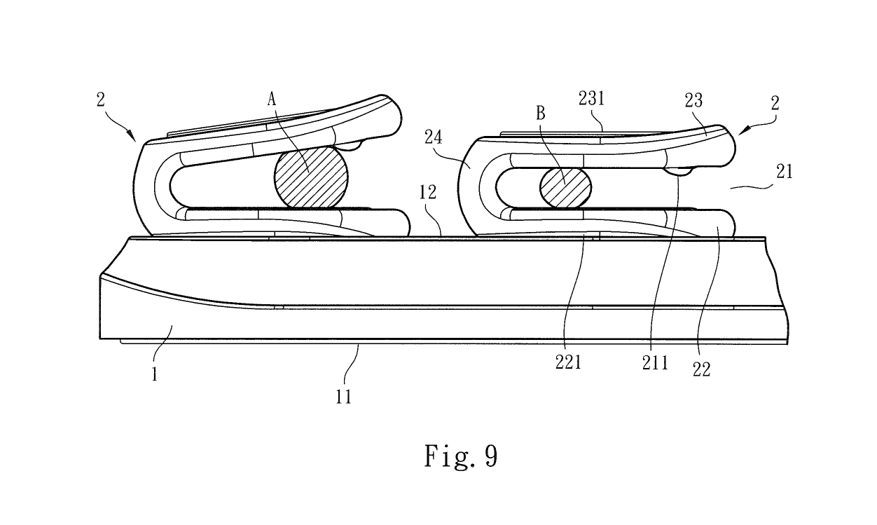

Please refer to FIGS. 7 to 9. The electronic cable collection device of the present invention mainly includes a base seat 1 and a holding member 2. The base seat 1 has a locating face 11 for locating the base seat 1 on a predetermined plane face (such as a wall or a table face) and a plane connection face 12. At least one magnetic attraction body 13 with magnetism, (which can be a magnet) is disposed in the base seat 1.

The holding member 2 has a holding mouth 21 inward recessed from a periphery of the holding member 2. An elastically bendable and deformable lateral holding section 22 is disposed on at least one side of the holding mouth 21. In addition, a magnetic attracted body 221, (which can be a magnet, an iron member or any other magnetic permeable material) is inlaid in one side of the lateral holding section 22 distal from the holding mouth 21.

In use, various fine, middle and coarse electronic cables C, B, A (such as signal transmission cables and charging cables) with a diameter slightly larger than the width of the opening of the holding mouth 21 can be directly extended into the holding mouth 21. At this time, the lateral holding section 22 is forcedly bent to elastically tightly hold the fine, middle and coarse electronic cables C, B, A. Thereafter, the lateral holding section 22 gets close to the connection face 12 and the magnetic attraction body 13 attracts the magnetic attracted body 221 so that the holding members 2 respectively holding the fine, middle and coarse electronic cables C, B, A can be easily and quickly located on the connection face 12 of the base seat 1. Accordingly, by means of the holding members 2, the fine, middle and coarse electronic cables C, B, A can be tidily arranged (without tangling with each other) to keep a beautiful appearance and facilitate the use.

In a preferred embodiment, a raised section 211 is disposed on an inner side of the lateral holding section 22 in adjacency to the opening of the holding mouth 21. In case a coarse electronic cable A with a larger diameter is placed in the holding mouth 21, the raised section 211 at the opening serves to prevent the coarse electronic cable A from slipping out of the holding mouth 21.

In the above structure, within the elastic bending range of the lateral holding section 22, the holding mouth 21 can have considerable restoring elasticity by a certain opening angle to hold the fine, middle and coarse electronic cables C, B, A with different diameters. Accordingly, it is quite convenient to hold the cables and the application range is widened.

In a preferred embodiment, two elastically bendable and deformable lateral holding sections 22, 23 are respectively disposed on two sides of the holding mouth 21 of the holding member 2. A connection section 24 is disposed between one side of the two lateral holding sections 22, 23 to connect the two lateral holding sections 22, 23 with each other. In addition, two magnetic attracted bodies 221, 231 are respectively inlaid in one side of each lateral holding sections 22, 23 distal from the holding mouth 21 to be magnetically attracted by the magnetic attraction body 13. Therefore, the magnetic attracted body 221 of the lateral holding section 22 or the magnetic attracted body 222 of the lateral holding section 23 of the holding member 2 can be selectively to be attracted by the magnetic attraction body 13 to locate the holding member 2. This further enhances the convenience in use of the holding member 2.

In this embodiment, the holding member 2 is a structure body with a cross section in the form of a flat disc (such as a short cylindrical body). The holding mouth 21 of the holding member 2 is positioned on a lateral side of the middle of the holding member 2. However, in practice, the holding member 2 can be any thin structure body with any other cross-sectional configuration.

In a preferred embodiment, the base seat 1 can be an elongated body. Multiple magnetic attraction bodies 13 are arranged in the base seat 1 at intervals as necessary. Accordingly, when multiple holding members 2 are rested on the connection face 12, the magnetic attracted body 221 (or 231) of the lateral holding section 22 (or 23) of each holding member 2 can be respectively attracted by the corresponding magnetic attraction bodies 13 so as to locate all the holding members 2 on the connection face 12.

The magnetic attraction body 13 is disposed (embedded) in the base seat 1 and each magnetic attracted body 221 (or 231) is inlaid in the surface of one side of the lateral holding section 22 (or 23) distal from the holding mouth 21. Therefore, in practice, both the magnetic attraction bodies 13 and the magnetic attracted body 221 (or 231) will not loosen or detach outward during the operation process. Accordingly, the base seat 1 and the holding members 2 are effectively prevented from failing to magnetically attracting each other due to damage.

In conclusion, the electronic cable collection device of the present invention is truly able to widen the application range to hold various diameters of electronic cables and enhance the reliability of the product and the convenience in use of the product.

The above embodiments are only used to illustrate the present invention, not intended to limit the scope thereof. Many modifications of the above embodiments can be made without departing from the spirit of the present invention.

What is claimed is:

1. An electronic cable collection device comprising:
a holding member having a holding mouth inward recessed from a periphery of the holding member, a lateral holding section with elastically holding ability being disposed on at least one side of the holding mouth, a magnetic attracted body being disposed in the lateral holding section, whereby the magnetic attracted body and a magnetic attraction body can attract each other.

2. The electronic cable collection device as claimed in claim 1, wherein two lateral holding sections are respectively disposed on two sides of the holding mouth of the holding member, a connection section being connected between the two lateral holding sections, two magnetic attracted bodies being respectively disposed in the lateral holding sections to be attracted by the magnetic attraction body, whereby any of the magnetic attracted bodies of the two lateral holding sections of the holding member can be attracted by the magnetic attraction body to locate the holding member.

3. The electronic cable collection device as claimed in claim 1, wherein the magnetic attracted body is inlaid in one side of the lateral holding section distal from the holding mouth.

4. The electronic cable collection device as claimed in claim 2, wherein the magnetic attracted body is inlaid in one side of the lateral holding section distal from the holding mouth.

5. The electronic cable collection device as claimed in claim 1, wherein the holding member is a structure body with a cross section in the form of a flat disc.

6. The electronic cable collection device as claimed in claim 2, wherein the holding member is a structure body with a cross section in the form of a flat disc.

7. The electronic cable collection device as claimed in claim 1, wherein a raised section is disposed on an inner side of the lateral holding section in adjacency to an opening of the holding mouth.

8. The electronic cable collection device as claimed in claim 2, wherein a raised section is disposed on an inner side of the lateral holding section in adjacency to an opening of the holding mouth.

9. The electronic cable collection device as claimed in claim 3, wherein a raised section is disposed on an inner side of the lateral holding section in adjacency to an opening of the holding mouth.

10. The electronic cable collection device as claimed in claim 5, wherein a raised section is disposed on an inner side of the lateral holding section in adjacency to an opening of the holding mouth.

11. An electronic cable collection device comprising a base seat applicable to the holding member as claimed in claim 1, the base seat being fixed on a predetermined plane face, at least one magnetic attraction body with magnetism being disposed in the base seat, at least one plane connection face being disposed on a surface of the base seat.

12. The electronic cable collection device as claimed in claim 11, wherein two lateral holding sections are respectively disposed on two sides of the holding mouth of the holding member, a connection section being connected between the two lateral holding sections, two magnetic attracted bodies being respectively disposed in the lateral holding sections to be attracted by the magnetic attraction body, whereby any of the magnetic attracted bodies of the two lateral holding sections of the holding member can be attracted by the magnetic attraction body to locate the holding member.

13. The electronic cable collection device as claimed in claim 11, wherein the magnetic attracted body is inlaid in one side of the lateral holding section distal from the holding mouth.

14. The electronic cable collection device as claimed in claim 11, wherein the holding member is a structure body with a cross section in the form of a flat disc.

15. The electronic cable collection device as claimed in claim 13, wherein the holding member is a structure body with a cross section in the form of a flat disc.

16. The electronic cable collection device as claimed in claim 11, wherein a raised section is disposed on an inner side of the lateral holding section in adjacency to an opening of the holding mouth.

17. The electronic cable collection device as claimed in claim 11, wherein multiple magnetic attraction bodies are arranged in the base seat at intervals and the magnetic attracted bodies in the lateral holding sections of multiple holding members are respectively attracted by the corresponding magnetic attraction bodies so as to locate all the holding members holding the electronic cables on the connection face.

18. The electronic cable collection device as claimed in claim 12, wherein multiple magnetic attraction bodies are arranged in the base seat at intervals and the magnetic attracted bodies in the lateral holding sections of multiple holding members are respectively attracted by the corresponding magnetic attraction bodies so as to locate all the holding members holding the electronic cables on the connection face.

19. The electronic cable collection device as claimed in claim 15, wherein multiple magnetic attraction bodies are arranged in the base seat at intervals and the magnetic attracted bodies in the lateral holding sections of multiple holding members are respectively attracted by the corresponding magnetic attraction bodies so as to locate all the holding members holding the electronic cables on the connection face.

20. The electronic cable collection device as claimed in claim 1, wherein the magnetic attraction body is a magnet, while the magnetic attracted body is a magnet or an iron member.

21. The electronic cable collection device as claimed in claim 2, wherein the magnetic attraction body is a magnet, while the magnetic attracted body is a magnet or an iron member.

22. The electronic cable collection device as claimed in claim 3, wherein the magnetic attraction body is a magnet, while the magnetic attracted body is a magnet or an iron member.

23. The electronic cable collection device as claimed in claim 7, wherein the magnetic attraction body is a magnet, while the magnetic attracted body is a magnet or an iron member.

24. The electronic cable collection device as claimed in claim 11, wherein the magnetic attraction body is a magnet, while the magnetic attracted body is a magnet or an iron member.

25. The electronic cable collection device as claimed in claim 12, wherein the magnetic attraction body is a magnet, while the magnetic attracted body is a magnet or an iron member.
